(19) United States
(12) Patent Application Publication
(10) Pub. No.: US 2025/0180495 A1
(43) Pub. Date: Jun. 5, 2025

(54) X-RAY DIFFRACTION DATA PROCESSING DEVICE AND X-RAY ANALYSIS DEVICE

(71) Applicant: RIGAKU CORPORATION, Akishima-shi, Tokyo (JP)

(72) Inventors: Aya Ogi, Tokyo (JP); Shintaro Kobayashi, Tokyo (JP); Koichi Kajiyoshi, Tokyo (JP)

(73) Assignee: RIGAKU CORPORATION, Akishima-shi, Tokyo (JP)

(21) Appl. No.: 18/844,692

(22) PCT Filed: Mar. 6, 2023
(86) PCT No.: PCT/JP2023/008314

§ 371 Date: Sep. 6, 2024

(30) Foreign Application Priority Data
Mar. 7, 2022 (JP) 2022-034251

(51) Int. Cl. G01N 23/2055; G01N 23/20025; G01N 23/207

(52) U.S. Cl. CPC G01N 23/2055; G01N 23/20025; G01N 23/207; G01N 2223/056; G01N 2223/1016

(57) ABSTRACT

A peak two-dimensional detection data extracting unit 211 extracts two-dimensional detection data (peak two-dimensional detection data) of diffracted X-rays Xb presenting maximum X-ray intensity from two-dimensional detection data of the diffracted X-rays Xb obtained at a plurality of scan angles 2θ/θ. Next, a peak position identifying unit 212 identifies, from the peak two-dimensional detection data, a position at which the X-ray intensity is maximum (peak position). Then, data processing is performed using position information of the peak position identified for the peak two-dimensional detection data.

### TECHNICAL FIELD

The present invention relates to an X-ray diffraction data processing device that processes two-dimensional detection data of diffracted X-rays obtained at a plurality of scan angles 2θ/θ by using an X-ray analysis device for detecting diffracted X-rays diffracted by a sample using a two-dimensional X-ray detector, and an X-ray analysis device using the same device.

### BACKGROUND ART

It has been conventionally performed in an X-ray analysis device that various adjustments are made before starting measurement in order to obtain a desired analysis result, which has resulted in a problem of increasing the overall time required to obtain measurement data.

For example, in an X-ray analysis called rocking curve measurement, as disclosed in Patent Literature 1 and Non-Patent Literature 1, it is necessary to adjust the tilting axis (tilting axis adjustment) before starting the measurement such that reciprocal lattice points are present on a scattering plane formed by incident X-rays and diffracted X-rays. This is because if the reciprocal lattice points are displaced from the scattering plane, the positions and widths of diffraction peaks detected by a two-dimensional X-ray detector would differ from actual values, which causes a risk that precision of analysis deteriorates.

### CITATION LIST

### Patent Literature

Patent Literature 1: Japanese Unexamined Patent
Application Publication No. 2010-249784

### Non Patent Literature

Non Patent Literature 1: Takayuki Kontani, “X-ray thin-film measurement techniques III. High resolution X-ray diffractometry”, Rigaku Journal 39 (2), 2008, pp. 10-17

### DISCLOSURE OF INVENTION

### Technical Problem

The present invention has been made in consideration of the problem of the conventional technique described above, and has an object to eliminate the requirement for various adjustments before starting measurement by improving the processing content of measurement data, thereby shortening an overall time required to acquire measurement data.

### Solution to Problem

An X-ray diffraction data processing device according to the present invention is an X-ray diffraction data processing device for scanning an incident angle θ of incident X-rays and an angular direction of 2θ in which a two-dimensional X-ray detector is arranged, and processing two-dimensional detection data of diffracted X-rays obtained at a plurality of scan angles 2θ/θ by using an X-ray analysis device in which a measurement point set on a surface of a sample is irradiated with the incident X-rays in a direction of the incident angle θ, the two-dimensional X-ray detector is arranged in the angular direction of 2θ with respect to the direction of the incident angle θ, and diffracted X-rays diffracted by the sample are detected by the two-dimensional X-ray detector, includes a peak two-dimensional detection data extracting unit for extracting two-dimensional detection data of diffracted X-rays presenting maximum X-ray intensity (peak two-dimensional detection data)) from the two-dimensional detection data of the diffracted X-rays obtained at the plurality of scan angles 2θ/θ, a peak position identifying unit for identifying, from the peak two-dimensional detection data, a position at which X-ray intensity is maximum (peak position), and a data processing unit for executing data processing using position information of the peak position identified for the peak two-dimensional detection data.

Further, in the X-ray diffraction data processing device according to the present invention, the data processing unit includes a target region setting unit for setting a target region surrounding the peak position, and a profile creating unit for integrating X-ray intensities within a region corresponding to the target region for each of the two-dimensional detection data of the diffracted X-rays obtained at the plurality of scan angles 2θ/θ, and creating a rocking curve profile based on X-ray intensity integrated for each of the two-dimensional detection data.

Furthermore, in the X-ray diffraction data processing device according to the present invention, the two-dimensional X-ray detector has a detection surface for detecting diffracted X-rays, and a reference detection point is set in advance on the detection surface, the two-dimensional X-ray detector is arranged such that when a surface of a symmetrically reflective sample is irradiated with incident X-rays in a direction of an incident angle θ, an optical axis of diffracted X-rays appearing from the surface of the sample in a direction of a diffraction angle 2θ is incident onto the reference detection point, and the peak position identifying unit is configured to determine an offset amount between the peak position recorded in the peak two-dimensional detection data and the reference detection point.

Here, the peak position identifying unit is configured to determine Δω and Δχ as offset amounts between the peak position and the reference detection point, where Δω) represents an offset amount along a locus ω of the reference detection point caused by 2θ/θ scan, and Δχ represents an offset amount along a circular locus χ centered on the reference detection point at a scan angle 2θ/θ=0°.

Furthermore, in the X-ray diffraction data processing device according to the present invention, the target region setting unit has a function of arbitrarily adjusting a width of the target region surrounding the peak position, the width corresponding to the angular direction of 2θ.

Furthermore, in the X-ray diffraction data processing device according to the present invention, the data processing unit includes a peak shift amount calculating unit for calculating a shift amount of the scan angle 2θ/θ by comparing the scan angled 2θ/θ of the peak two-dimensional detection data acquired for a plurality of measurement points on a straight line set on the surface of the sample that is a flat sample, and a radius-of-curvature calculating unit for calculating a radius of curvature of crystal lattice planes of the sample based on the shift amount of the scan angle 2θ/θ calculated by the peak shift amount calculating unit.

Next, an X-ray analysis device according to the present invention in an X-ray analysis device in which a measurement point set on a surface of a sample is irradiated with incident X-rays in a direction of an incident angle θ, a two-dimensional X-ray detector is arranged in an angular direction of 2θ with respect to the direction of the incident angle θ, and diffracted X-rays diffracted by the sample are detected by the two-dimensional X-ray detector, includes the X-ray diffraction data processing device having the above-described configuration.

The X-ray analysis device according to the present invention, further includes a sample stage for placing the sample thereon, the sample stage being freely movable up and down, and a sample stage controller having a function of controlling at least a height of the sample stage, wherein the sample stage controller is configured to adjust the height of the sample stage based on the peak position related to the peak two-dimensional detection data.

Furthermore, in the X-ray analysis device according to the present invention, the X-ray diffraction data processing device includes: a storage unit for storing the peak position (reference height peak position) of the sample for the peak two-dimensional detection data obtained when the sample is placed at a reference height, the reference height being defined as a height of the sample in a state where the measurement point set on the surface of the sample is placed at an irradiation point of the incident X-rays; and a height deviation amount calculating unit for comparing the peak position in peak two-dimensional detection data obtained when the sample is placed at an arbitrary height position with the reference height peak position to determine a positional deviation amount between the peak position and the reference height peak position, and calculating a deviation amount of the arbitrary height position from the reference height based on the positional deviation amount, wherein the sample stage controller is configured to move the sample placed at the arbitrary height position to the reference height based on the deviation amount of the arbitrary height position calculated by the height deviation amount calculating unit.

Next, an X-ray diffraction data processing method according to the present invention is an X-ray diffraction data processing method to be performed by an X-ray diffraction data processing device for scanning an incident angle θ of incident X-rays and an angular direction of 2θ in which a two-dimensional X-ray detector is arranged, and processing two-dimensional detection data of diffracted X-rays obtained at a plurality of scan angles 2θ/θ in an X-ray analysis device in which a measurement point set on a surface of a sample is irradiated with the incident X-rays in a direction of the incident angle θ, the two-dimensional X-ray detector is arranged in the angular direction of 2θ with respect to the direction of the incident angle θ, and diffracted X-rays diffracted by the sample are detected by the two-dimensional X-ray detector, the X-ray diffraction data processing method including: a peak two-dimensional detection data extracting step of extracting two-dimensional detection data of diffracted X-rays presenting maximum X-ray intensity (peak two-dimensional detection data) from the two-dimensional detection data of the diffracted X-rays obtained at the plurality of scan angles 2θ/θ; a peak position identifying step of identifying, from the peak two-dimensional detection data, a position at which X-ray intensity is maximum (peak position); and a data processing step of executing data processing using position information of the peak position identified for the peak two-dimensional detection data.

An X-ray diffraction data processing program according to the present invention is an X-ray diffraction processing program to be executed by an X-ray diffraction data processing device for scanning an incident angle θ of incident X-rays and an angular direction of 2θ in which a two-dimensional X-ray detector is arranged, and processing two-dimensional detection data of diffracted X-rays obtained at a plurality of scan angles 2θ/θ in an X-ray analysis device in which a measurement point set on a surface of a sample is irradiated with the incident X-rays in a direction of the incident angle θ, the two-dimensional X-ray detector is arranged in the angular direction of 2θ with respect to the direction of the incident angle θ, and diffracted X-rays diffracted by the sample are detected by the two-dimensional X-ray detector, the X-ray diffraction data processing program including: a peak two-dimensional detection data extracting step of extracting two-dimensional detection data of diffracted X-rays presenting maximum X-ray intensity (peak two-dimensional detection data) from the two-dimensional detection data of the diffracted X-rays obtained at the plurality of scan angles 2θ/θ; a peak position identifying step of identifying, from the peak two-dimensional detection data, a position at which X-ray intensity is maximum (peak position); and a data processing step of executing data processing using position information of the peak position identified for the peak two-dimensional detection data.

### BRIEF DESCRIPTION OF DRAWINGS

FIG. 1A is a schematic diagram showing an operation of an X-ray diffraction device when rocking curve measurement is performed on a thin-film substrate sample, and FIG. 1B is a graph showing information on the thin-film substrate sample to be analyzed from a rocking curve profile;

FIG. 2 is an overall configuration diagram showing an overview of an X-ray analysis device according to an embodiment of the present invention;

FIG. 3 is a block diagram showing a functional configuration of an X-ray diffraction data processing device according to the embodiment of the present invention;

FIG. 4 is a diagram showing a function of a peak two-dimensional detection data extracting unit;

FIG. 5A is a front view showing an enlarged two-dimensional image of peak two-dimensional detection data that is used to show a function of a peak position identifying unit, and FIG. 5B is a front view showing an enlarged two-dimensional image of peak two-dimensional detection data that is used to show a function of a target region setting unit;

FIG. 6A is a cross-sectional front view showing a surface and crystal lattice planes of a sample to show the relation of the position of diffracted X-rays to be recorded in the two-dimensional detection data, and the surface and crystal lattice planes of the sample, and FIG. 6B is a cross-sectional perspective view of the same;

FIG. 7 is a principle diagram showing the relation of the position of diffracted X-rays to be recorded in the two-dimensional detection data, and the surface and crystal lattice planes of the sample;

FIG. 8 is a front view showing an offset amount between the detection position of diffracted X-rays diffracted by an asymmetric reflection sample and a reference detection point in a two-dimensional image of two-dimensional detection data;

FIG. 9 is a diagram showing a function of creating a rocking curve profile by a target region setting unit and a profile creating unit;

FIG. 10-A1, FIG. 10-A2, FIG. 10-B1, FIG. 10-B2, FIG. 10-C1, and FIG. 10-C2 are diagrams showing a receiving slit function of the target region setting unit;

FIG. 11 is a flowchart showing a method for creating a rocking curve profile;

FIG. 12A is a front view of a thin-film substrate sample to show a function of a data processing unit for evaluating sample warpage, and FIG. 12B is a cross-sectional front view of the same sample;

FIG. 13A is an example of a graph showing peak values of diffracted X-ray Xb intensities for respective measurement points arranged along a peak angle to show the function of the data processing unit for evaluating sample warpage, and FIG. 13B is an example of a graph showing the relations between the peak angle and the position of each measurement point to show the function of the data processing unit for evaluating sample warpage; and

FIG. 14 is a schematic diagram showing a function of a data processing unit for adjusting a sample height.

### REFERENCE SIGNS LIST

10: diffraction peak, 20: target region,
100: X-ray diffraction device,
101: controller, 110: sample stage, 120: X-ray source,
121: X-ray irradiation unit, 130: two-dimensional X-ray
detector, 140: goniometer, 141:0 arm, 142:20 arm,
200: X-ray diffraction data processing device,
201: input/output unit, 202: storage unit,
210: pre-processing unit for two-dimensional detection data,
211: peak two-dimensional detection data extracting unit,
212: peak position identifying unit,
220: data processing unit for creating rocking curve profile,
221: target region setting unit, 222: profile creating unit,
230: data processing unit for evaluating sample warpage,
231: peak shift amount calculating unit, 232: radius-of-curvature calculating unit,
240: data processing unit for adjusting sample height, 241: peak position offset amount calculating unit, 242: height deviation amount calculating unit

### BEST MODE FOR CARRYING OUT THE INVENTION

Hereinafter, an embodiment of the present invention will be described in detail with reference to the drawings. In the present embodiment, there will be described an example of a configuration in which the present invention is applied to an X-ray analysis device for analyzing the film thickness, composition, etc. of a thin film by rocking curve measurement using, as a sample, a thin-film substrate such as a semiconductor wafer having a thin-film crystal formed on a substrate crystal.

### [Outline of Rocking Substrate Sample] Curve Measurement for Thin-Film

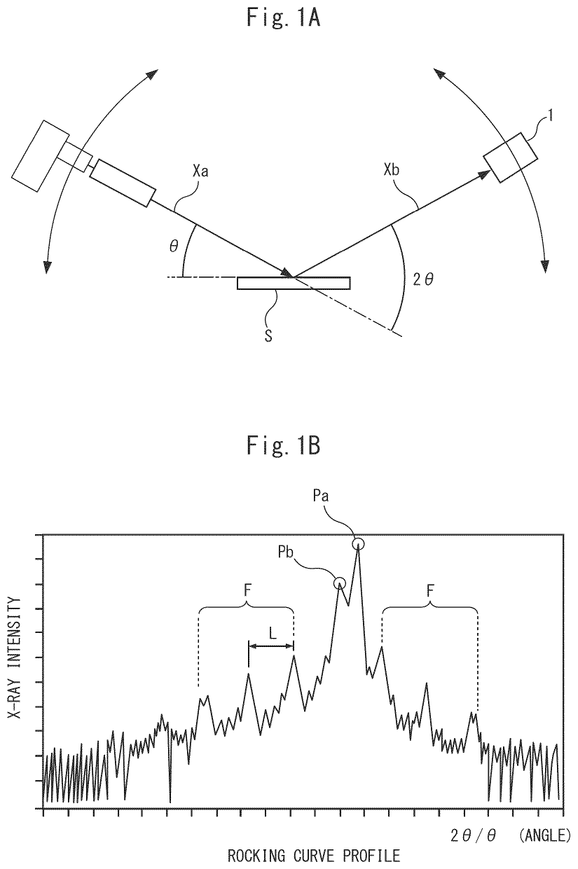

First, an outline of X-ray analysis by rocking curve measurement for a thin-film substrate sample will be described with reference to FIG. 1A and FIG. 1B.

FIG. 1A is a schematic diagram showing an operation of an X-ray diffraction device when rocking curve measurement is performed.

As shown in FIG. 1A, incident X-rays Xa are irradiated onto a surface of a thin-film substrate sample (hereinafter sometimes simply referred to as a sample) S at an incident angle θ, and diffracted X-rays Xb that appear in the direction of a diffraction angle 2θ with respect to the optical axis of the incident X-rays Xa are detected by an X-ray detector 1 (X-ray diffraction measurement).

In the rocking curve measurement, the X-ray detector 1 is moved in the direction of the diffraction angle 2θ while the incident angle θ of the incident X-rays Xa onto the surface of the sample S is changed, and X-ray diffraction measurement is repeated at a plurality of scan angles 2θ/θ.

A rocking curve profile as shown in FIG. 1B is created based on the diffracted X-ray intensity obtained at each scan angle 2θ/θ. This rocking curve profile is a graph of the detection data obtained in the rocking curve measurement with a horizontal axis representing the scan angle 2θ/θ and a vertical axis representing the diffracted X-ray intensity.

From the rocking curve profile in FIG. 1B, for example, from peak values Pa and Pb of the diffracted X-ray intensity, it is possible to know the composition of a material constituting the thin-film substrate sample S, and further from the period L of the amplitude F called fringes that appear around the peak values, it is possible to determine the film thickness of the thin-film substrate sample S.

### [Overview of X-ray Analysis Device]

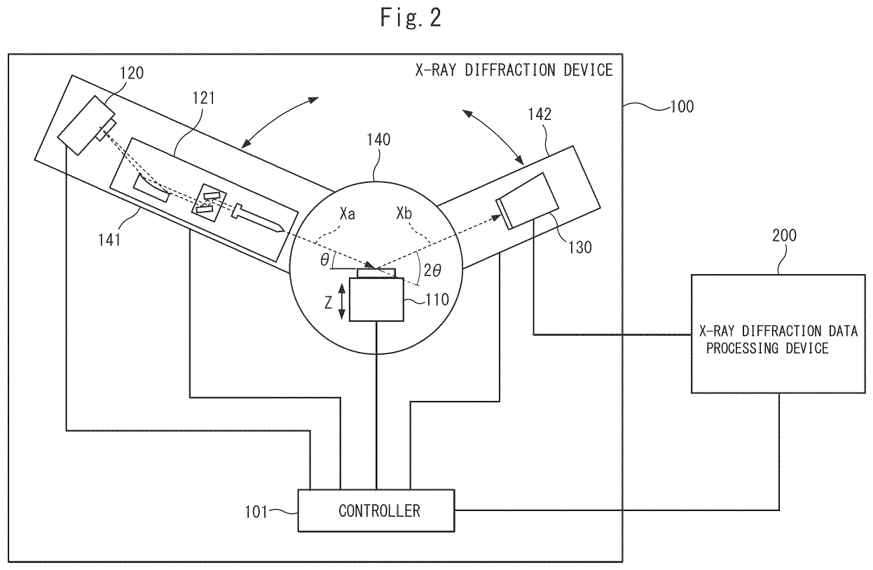

FIG. 2 is an overall configuration diagram showing an overview of the X-ray analysis device according to the present embodiment.

The X-ray analysis device is configured by combining an X-ray diffraction device 100 for performing X-ray diffraction measurement to acquire measurement data, and an X-ray diffraction data processing device 200 for processing the measurement data acquired by the X-ray diffraction device 100.

The operation of the X-ray diffraction device 100 is controlled by a controller 101. This controller 101 is configured, for example, by a computer in which a dedicated control program is installed. The X-ray diffraction data processing device 200 is also configured, for example, by a computer in which a dedicated X-ray diffraction data processing program is installed.

The X-ray diffraction device 100 includes a sample stage 110 on which a sample S is placed, an X-ray source 120 and an X-ray irradiation unit 121 that irradiate the surface of the sample S with X-rays, and a two-dimensional X-ray detector 130 for detecting diffracted X-rays Xb diffracted by the sample S.

The sample stage 110 to be used in the present embodiment has a mechanism that can move at least in a vertical direction the height position of the sample S.

Here, as described later, the controller 101 also functions as a sample stage controller, and controls the height of the sample stage 110 based on processing data related to a height deviation amount of the sample S output from the X-ray diffraction data processing device 200.

The X-ray irradiation unit 121 includes an X-ray mirror and a monochromator that extract only X-rays having a specific wavelength from X-rays emitted from the X-ray source 120 and monochromatize and collimate the extracted X-rays, a collimator that limits the beam diameter of the monochromatized X-rays, and the like. Note that the X-ray irradiation unit 121 is configured by combining various known X-ray optical components (for example, a monochromator, a collimator, various slits, etc.) depending on a measurement purpose, etc.

The two-dimensional X-ray detector 130 has a function that can detect the intensity and incident position of X-rays incident onto a detection surface.

In the present embodiment, the X-ray source 120 and the X-ray irradiation unit 121 are mounted in a θ arm 141 of a goniometer 140, and the two-dimensional X-ray detector 130 is mounted in a 2θarm 142 of the goniometer 140. The X-ray source 120, the X-ray irradiation unit 121, and the two-dimensional X-ray detector 130 are configured to rotate while maintaining a θ-2θ relationship with respect to the surface of the horizontally placed sample S. In other words, according to Bragg's law, when X-rays are irradiated onto the surface of the sample S at an incident angle θ as shown in FIG. 2, diffracted X-rays Xb appear in the direction of a diffraction angle 2θ with respect to the optical axis of the incident X-rays Xa. Therefore, the goniometer 140 drives the θ arm 141 and the 2θarm 142 such that the X-ray source 120 and the X-ray irradiation unit 121 are arranged at positions where X-rays are irradiated in the direction of the incident angle θ with respect to a measurement point set on the surface of the sample S, and the two-dimensional X-ray detector 130 is arranged in the direction of the diffraction angle 2θ with respect to the optical axis of the incident X-rays Xa.

Note that the X-ray diffraction device 100 may be configured such that the X-ray source 120 and the X-ray irradiation unit 121 are fixed, and the sample stage 110 is rotated with respect to the incident X-rays Xa to tilt the surface of the sample S so that the surface of the sample S is irradiated with X-rays in the direction of the incident angle θ.

In the present embodiment, the X-ray diffraction device 100 configured as described above is operated to scan the incident angle θ of the incident X-rays Xa and the angular direction of 2θ in which the two-dimensional X-ray detector 130 is arranged, and two-dimensional detection data of the diffracted X-rays Xb is obtained at each of a plurality of scan angles 2θ/θ. These two-dimensional detection data of the diffracted X-rays Xb are output from the two-dimensional X-ray detector 130, converted into two-dimensional image data corresponding to the detection surface of the two-dimensional X-ray detector 130, and stored in the X-ray diffraction data processing device 200.

Therefore, data processing is performed on the two-dimensional detection data in a state where the two-dimensional detection data have been converted into two-dimensional image data corresponding to the detection surface of the two-dimensional X-ray detector 130.

### [Functional Configuration of X-ray Diffraction Data Processing Device]

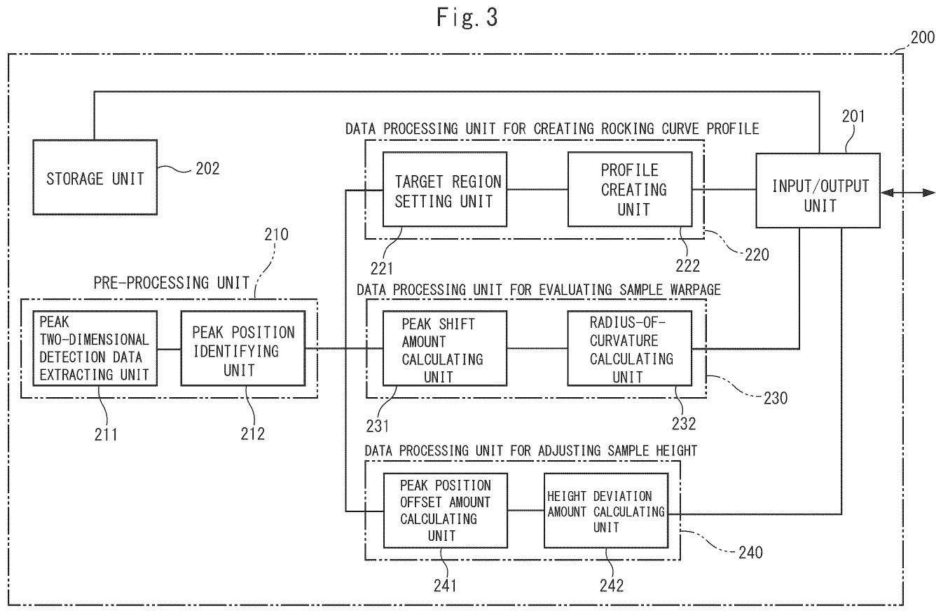

FIG. 3 is a block diagram showing a functional configuration of the X-ray diffraction data processing device according to the present embodiment.

Each functional unit shown in FIG. 3 is configured, for example, by the hardware of a computer described above and a dedicated X-ray diffraction data processing program installed on the computer.

The X-ray diffraction data processing device 200 includes respective functional units of an input/output unit 201, a storage unit 202, a pre-processing unit for two-dimensional detection data 210, and a data processing unit for processing the two-dimensional detection data according to the purpose.

The input/output unit 201 is a functional unit that is connected to the two-dimensional X-ray detector 130 and the controller 101 of the X-ray diffraction device 100, and executes data input and output with these devices. Furthermore, although not shown in the figures, a display device such as a liquid crystal display and an input device such as a keyboard are also connected to the X-ray diffraction data processing device 200 via the input/output unit 201.

The storage unit 202 is a functional unit for storing various types of data. Two-dimensional detection data of the diffracted X-rays Xb output from the two-dimensional X-ray detector 130 of the X-ray diffraction device 100 is stored in the storage unit 202 via the input/output unit 201. Furthermore, various types of information necessary for data processing, such as information about the X-ray diffraction device 100 and information about the sample S are stored in advance in the storage unit 202. Furthermore, data processed by each functional unit of the X-ray diffraction data processing device 200 is also stored in the storage unit 202 as appropriate. Each functional unit of the X-ray diffraction data processing device 200 reads out data stored in the storage unit 202 and executes processing on the read-out data as appropriate.

In the present embodiment, the data processing unit is configured to be divided into the respective functional units of a data processing unit for creating a rocking curve profile 220, a data processing unit for evaluating the warpage of the sample 230, and a data processing unit for adjusting the height of the sample 240.

The functions of the pre-processing unit for the two-dimensional detection data 210 and each data processing unit will be described below in separate sections.

[Pre-processing Unit for Two-dimensional Detection Data]

The pre-processing unit for two-dimensional detection data 210 includes the respective functional units of a peak two-dimensional detection data extracting unit 211, and a peak position identifying unit 212.

The peak two-dimensional detection data extracting unit 211 extracts two-dimensional detection data of the diffracted X-rays Xb presenting the maximum X-ray intensity (peak two-dimensional detection data) from the two-dimensional detection data of the diffracted X-rays Xb obtained at a plurality of scan angles 2θ/θ.

Specifically, the peak two-dimensional detection data extracting unit 211 first reads out, from the storage unit 202, two-dimensional detection data (two-dimensional image data) of the diffracted X-rays Xb that are stored in the storage unit 202, and calculates the total intensity of X-rays (total X-ray intensity) recorded in each two-dimensional detection data. Then, the total X-ray intensities of the respective pieces of two-dimensional detection data are compared with one another, and the two-dimensional detection data having the maximum total X-ray intensity is extracted as the peak two-dimensional detection data.

Note that scattered X-rays and the like other than the diffracted X-rays Xb from the sample S are also incident onto the detection surface of the two-dimensional X-ray detector 130, but the total X-ray intensity is calculated with all of those X-rays being included in the two-dimensional detection data.

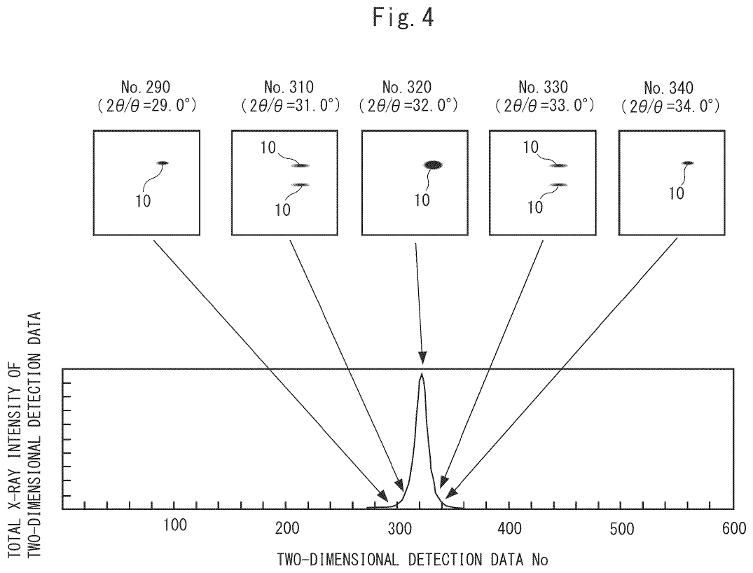

For example, with respect to a plurality of pieces of two-dimensional detection data shown in FIG. 4 (data Nos. 290, 310, 320, 330, 340), a diffraction peak 10 is recorded in each two-dimensional image, and the X-ray intensity for each diffraction peak 10 can be obtained from the light and shade of color or the like of the diffraction peak 10.

The following description will be made assuming that the plurality pieces of two-dimensional detection data shown in FIG. 4 are two-dimensional detection data detected at scan angles 2θ/θ as shown in FIG. 4.

As shown in a graph in FIG. 4, if the total X-ray intensity of each two-dimensional detection data is plotted in order of data number to create an intensity graph of the diffracted X-rays Xb, it is possible to visually extract it as peak two-dimensional detection data.

In the example shown in FIG. 4, the two-dimensional detection data of data No. 320 has the maximum total X-ray intensity recorded in the entire area of the two-dimensional image, so that the two-dimensional detection data of this data No. 320 is extracted as the peak two-dimensional detection data.

Next, the peak position identifying unit 212 identifies, from the peak two-dimensional detection data, a position (peak position) where the X-ray intensity is maximum.

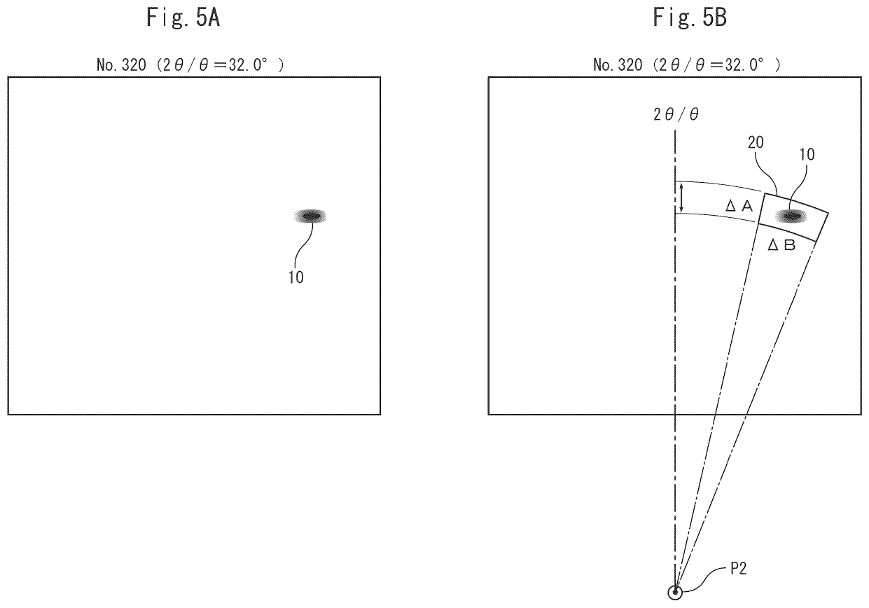

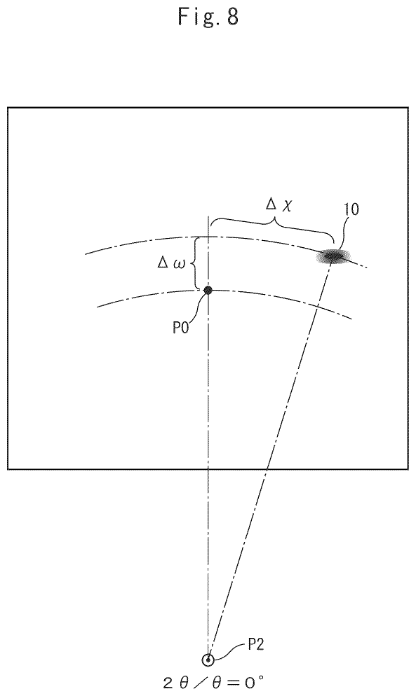

For example, in the two-dimensional image of the peak two-dimensional detection data of data No. 320 that is shown to be enlarged in FIG. 5A, a diffraction peak 10 is recorded at a position closer to an upper right side than the center position. The position of this diffraction peak 10 is identified as a peak position. Note that a method of identifying the position will be described later with reference to FIG. 8.

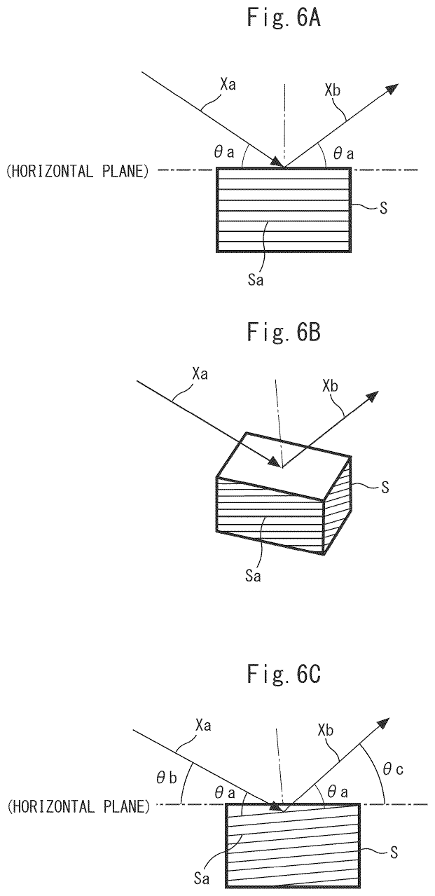

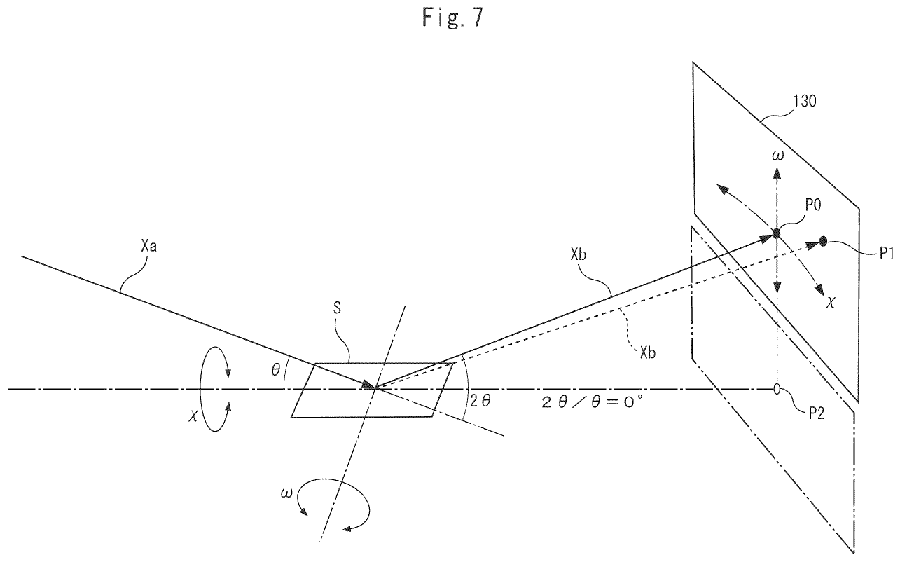

Here, the relation between the position of the diffracted X-rays Xb recorded in the two-dimensional detection data and the surface and crystal lattice planes Sa of the sample S will be described with reference to FIGS. 6A to 7.

As shown in FIG. 6A, in a case where the crystal lattice planes Sa present inside the sample S are arranged in parallel to the surface of the sample S, when the incident X-rays Xa are incident onto the crystal lattice planes Sa at an angle θa and then the diffracted X-rays Xb are reflected in an angular direction (θa) which is symmetrical with respect to the incident angle θa of the incident X-rays Xa, the diffracted X-rays Xb from the surface of the sample S also likewise appear in an angular direction (ea) which is symmetrical with respect to the incident angle θa of the incident X-rays Xa. This is called symmetric reflection.

On the other hand, as shown in FIG. 6B, in a case where the crystal lattice planes Sa present inside the sample S are arranged to be tilted at an angle with respect to the surface of the sample S, when the incident X-rays Xa are incident onto the crystal lattice planes Sa at an angle θa and then the diffracted X-rays Xb are reflected in a symmetrical angular direction (θa) as shown in FIG. 6C, the diffracted X-rays Xb from the surface of the sample S appear in an angular direction (θc) that is asymmetric with respect to the incident angle (θb) of the incident X-rays Xa. This is called asymmetric reflection.

In general, the X-ray diffraction device 100 is based on symmetric reflection, and as shown in FIG. 7, it is configured such that incident X-rays Xa are irradiated onto the surface of the sample S in the direction of an incident angle θ, the two-dimensional X-ray detector 130 is arranged in an angular direction of 2θ with respect to the direction of the incident angle θ, and diffracted X-rays Xb diffracted by the sample S are detected by the two-dimensional X-ray detector 130. The X-ray diffraction device 100 of the present embodiment shown in FIG. 2 also has a similar configuration.

Note that as shown in FIG. 6A, the sample stage 110 is normally arranged such that the surface of the sample S is horizontally oriented with a horizontal plane set as a reference plane, but the arrangement of the sample stage 110 is not limited to this style.

The two-dimensional X-ray detector 130 is adjusted such that diffracted X-rays Xb appearing from the surface of the sample S in the direction of a diffraction angle 2θ are incident onto a reference detection point P0 (usually, the center position) that is set in advance on the detection surface.

As a result, with respect to an asymmetric reflection sample S in which the crystal lattice planes Sa are arranged to be tilted at an angle with respect to the surface of the sample S, the diffracted X-rays Xb are incident onto a position P1 that is deviated from the reference detection point P0 as shown in FIG. 7.

FIG. 8 is a front view showing an offset amount between the detection position of the diffracted X-rays Xb diffracted by the asymmetric reflection sample S and the reference detection point P0 in the two-dimensional image of the two-dimensional detection data.

In the present embodiment, the peak position identifying unit 212 shown in FIG. 3 identifies a peak position (a position where a diffraction peak 10 is stored) recorded in the two-dimensional image of the peak two-dimensional detection data based on offset amounts Δω and Δχ between the peak position and reference detection point P0.

Here, Δω represents an offset amount along a locus ω which is drawn by the reference detection point P0 set on the detection surface of the two-dimensional X-ray detector 130 when the X-ray diffraction device 100 executes 2θ/θ scan as shown in FIG. 7. To put it shortly, this is an offset amount along the locus ω of the reference detection point P0 which is caused by the 2θ/θ scan.

Furthermore, Δχ represents an offset amount along a circular locus χ centered on a position P2 where the incident X-rays Xa are directly incident onto the detection surface of the two-dimensional X-ray detector 130 at a scan angle 2θ/θ=0° (i.e., the reference detection point P0 at a scan angle) 2θ/θ=0°.

In the rocking curve measurement, when the diffracted X-rays Xb are incident onto a position which is offset from the reference detection point P0 of the two-dimensional X-ray detector 130, there is a risk that the precision of analysis deteriorates because the position and width of the diffraction peak detected by the two-dimensional X-ray detector 130 differ from actual values thereof. For this reason, an adjustment (tilting axis adjustment) for rotating the sample S around w-axis or x-axis shown in FIG. 7 and tilting the surface of the sample S such that the diffracted X-rays Xb are incident onto the reference detection point P0 has been conventionally performed prior to measurement.

After this tilting axis adjustment, the diffracted X-rays Xb that have been incident onto the detection position shown in FIG. 8 are incident onto the reference detection point P0, so that the diffracted X-rays Xb are detected at an angle at which the scan angle 2θ/θ is shifted only by Aw. Therefore, the two-dimensional detection data (peak two-dimensional detection data) of the diffracted X-rays Xb which present the maximum X-ray intensity is also detected at the scan angle 2θ/θ shifted only by Δω after the tilting axis adjustment.

Therefore, in the X-ray analysis device of the present embodiment which does not perform tilting axis adjustment, data processing is performed in consideration of the offset amount of Δω for the scan angle 2θ/θ at which the two-dimensional detection data is obtained, whereby it is possible to perform data analysis with the same high accuracy as an X-ray analysis device on which tilting axis adjustment has been performed.

In addition, since no tilting axis adjustment is performed, it is possible to significantly reduce the time required to obtain measurement data.

### [Data Processing Unit For Creating Rocking Curve Profile]

Next, the data processing unit for creating a rocking curve profile 220 shown in FIG. 3 will be described. The data processing unit for creating a rocking curve profile 220 includes a target region setting unit 221 and a profile creating unit 222.

The target region setting unit 221 has a function of setting a target region 20 surrounding a peak position.

In other words, as shown in FIG. 5B, a diffraction peak 10 is recorded in a two-dimensional image of peak two-dimensional detection data. The position where this diffraction peak 10 is recorded is the peak position. The target region setting unit 221 sets a target region 20 having any size such that the target region 20 surrounds this peak position, based on instruction information from an operator which is input via an input device such as a keyboard.

In the present embodiment, the target region 20 is specified as a sector having a width ΔA and a length ΔB which is centered on the reference detection point P0 (position P2 in FIG. 5B) at the scan angle 2θ/θ=0° described above.

However, the shape and size of the target region 20 are not limited to this style.

Next, the profile creating unit 222 integrates the X-ray intensities in the region corresponding to the target region 20 for each of the two-dimensional detection data of the diffracted X-rays Xb obtained at a plurality of scan angles 2θ/θ, and creates a rocking curve profile based on the X-ray intensities integrated for each of the two-dimensional detection data.

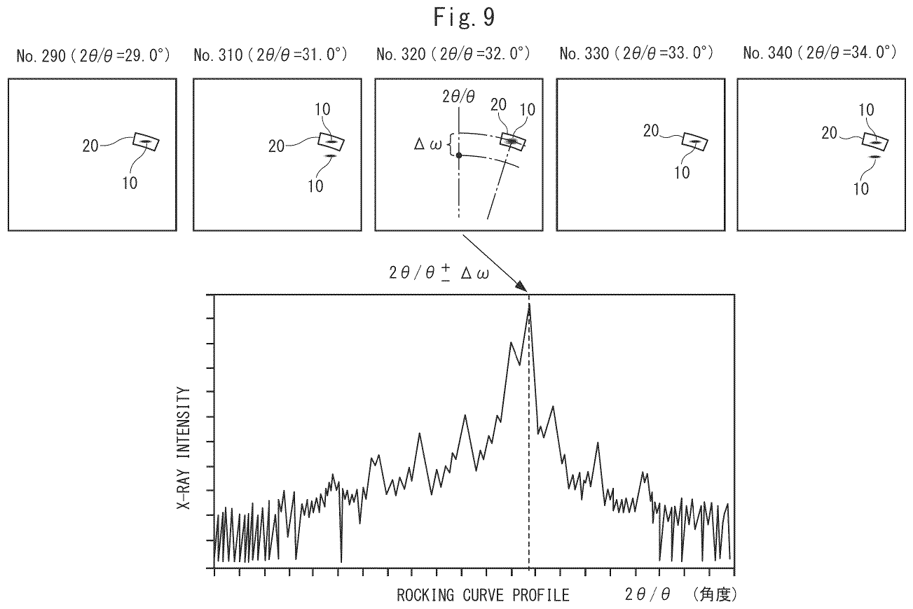

FIG. 9 is a diagram showing the function of creating a rocking curve profile by the target region setting unit and the profile creating unit.

For example, with respect to of the two-dimensional images of a plurality of pieces of two-dimensional detection data shown in FIG. 4, the target region setting unit 221 first sets a target region 20 in the two-dimensional image of the peak two-dimensional detection data (data No. 320). Next, the profile creating unit 222 integrates the X-ray intensities within this target region 20, and plots the integrated X-ray intensity on a rocking curve profile graph.

Here, the scan angle 2θ/θ at which the peak two-dimensional detection data (data No. 320) was obtained is 32.0°, but the offset amount Δω of the peak position described above is taken into consideration for the scan angle 2θ/θ under this measurement, and (2θ/θ)±Δω is set as the scan angle of the peak two-dimensional detection data (data No. 320). In other words, the X-ray intensity of the peak two-dimensional detection data (data No. 320) is plotted against the scan angle of (2θ/θ)±Δω.

By processing the data as described above, it is possible to create a rocking curve profile with high accuracy equivalent to that of a device on which tilting axis adjustment has been performed.

With respect to the two-dimensional images of the other two-dimensional detection data (data No. 290, 310, 330, 340), the target region setting unit 221 also sets target regions 20 at positions corresponding to the target region 20 set in the two-dimensional e of the peak two-dimensional detection data (data No. 320). Furthermore, with respect to the respective two-dimensional detection data (data No. 290, 310, 330, 340), the profile creating unit 222 integrates the X-ray intensities within the target region 20, and plots the integrated X-ray intensity on a rocking curve profile graph. At this time, the offset amount Δω is also taken into account, and (2θ/θ)±Δω is set as the scan angle of each of the two-dimensional detection data (data No. 290, 310, 330, 340).

For all the two-dimensional detection data acquired by the X-ray diffraction measurement, the target region 20 is set in the above-described procedure, the X-ray intensities within the target region 20 are integrated, and the integrated X-ray intensity is plotted on a rocking curve profile graph. As a result, a rocking curve profile as shown in FIG. 9 is created.

The offset amounts Δω and Δχ of the peak position determined in the procedure for creating the rocking curve profile described above are parameters for the tilt of the crystal lattice planes with respect to the surface, and these numerical values themselves can also be used to evaluate single crystal substrates.

Some single crystal substrates such as gallium arsenide (GaAs) substrates and silicon carbide (SiC) substrates are cut such that a specific crystal lattice plane has a specific tilt angle with respect to the surface. A procedure of performing ω scan at each scan angle 2θ/θ to determine Δω and performing χ scan to determine Δχ has been conventionally repeated for these single crystal substrates.

In contrast, in the X-ray diffraction data processing device according to the present embodiment, it is only necessary to perform 2θ/θ scan in order to determine Δω and Δχ in the process of creating the rocking curve, which makes it possible to quickly evaluate the offset amounts.

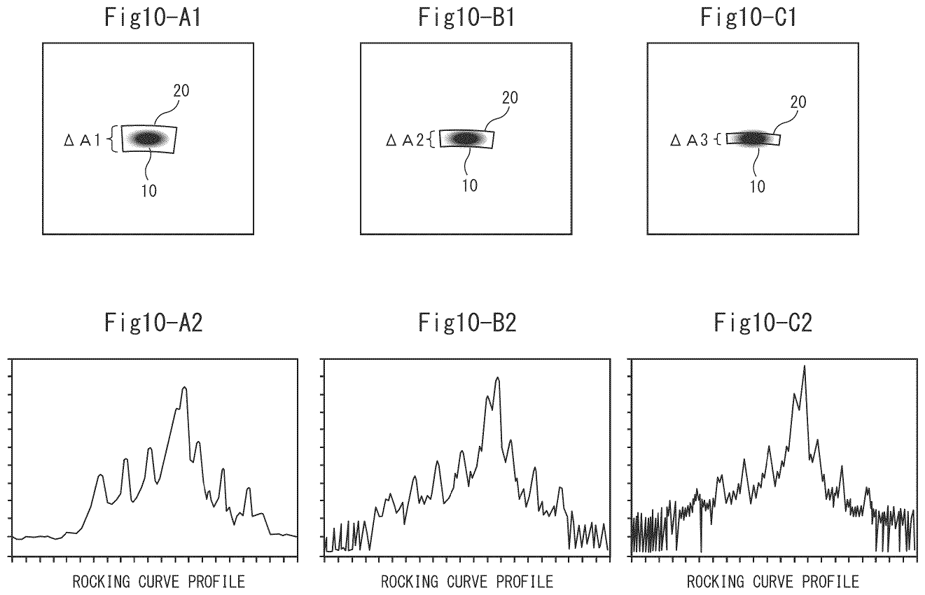

FIG. 10-A1 to FIG. 10-C2 are diagrams showing a receiving slit function of the target region setting unit.

The target region setting unit 221 has a receiving slit function for arbitrarily adjusting the width of the target region 20 surrounding the peak position in the direction of the scan angle 20.

As shown in FIG. 5B, increase or decrease of the width ΔA of the target region 20 set in a sector centered on the reference detection point P0 (position P2 in the figure) corresponds to increase or decrease of the width in the direction of the scan angle 20. The target region 20 set in the two-dimensional image of the two-dimensional detection data has a function of limiting the X-rays for which the X-ray intensity is calculated, like the receiving slit arranged in front of the two-dimensional X-ray detector 130 in the X-ray diffraction device 100, and increase or decrease of the width ΔA of the target region 20 has the same effect as increase or decrease of the width of the receiving slit.

For example, as shown in FIG. 10-A1, when the target region 20 is set to have a wide width ΔA1, a rocking curve profile having low resolution is created as shown in FIG. 10-A2. When the target region 20 is set to have a narrow width ΔA2 as shown in FIG. 10-B1, a rocking curve profile having improved resolution is created as shown in FIG. 10-B2. When the target region 20 is set to have a still narrower width ΔA3 as shown in FIG. 10-C1, a rocking curve profile having even improved resolution can be created as shown in FIG. 10-C2.

In this way, by narrowing the width of the target region 20 within a range that includes the diffracted X-rays Xb reflected from the sample S, it is possible to achieve a high resolution equivalent to that obtained by narrowing the width of the receiving slit.

Note that it is possible to achieve the same function as a receiving vertical limiting slit by arbitrarily adjusting the length ΔB of the target region 20 (the length corresponding to the direction perpendicular to the width in the direction of the scan angle 20).

### [Rocking Curve Profile Creating Method]

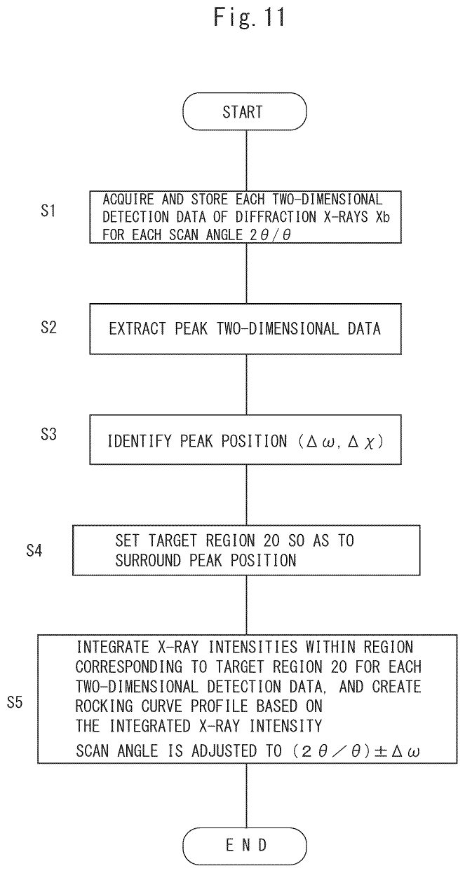

Next, a method for creating a rocking curve profile will be described with reference to FIG. 11.

First, the controller 101 shown in FIG. 2 controls each component of the X-ray diffraction device 100 to scan, for the sample S, the incident angle θ of the incident X-rays Xa and the angular direction of 2θ in which the two-dimensional X-ray detector 130 is arranged, and obtains two-dimensional detection data of the diffracted X-rays Xb at each of the plurality of scan angles 2θ/θ. These two-dimensional detection data of the diffracted X-rays Xb are output from the two-dimensional X-ray detector 130, converted into two-dimensional image data corresponding to the detection surface of the two-dimensional X-ray detector 130, and stored in the storage unit 202 of the X-ray diffraction data processing device 200 (step S1).

In the rocking curve profile creating method of the present embodiment, two-dimensional detection data of the diffracted X-rays Xb can be obtained one after another at a plurality of scan angles 2θ/θ without performing tilting axis adjustment, so that the measurement time required to obtain the two-dimensional detection data can be significantly shortened.

The X-ray diffraction data processing device 200 executes rocking curve profile creating processing in the following procedure based on a dedicated X-ray diffraction data processing program.

First, the peak two-dimensional detection data extracting unit 211 reads out, from the storage unit 202, two-dimensional detection data of the diffracted X-rays Xb obtained at a plurality of scan angles 2θ/θ, and calculates the total intensity of the X-rays (total X-ray intensity) recorded in each data of the two-dimensional detection data. The total X-ray intensities of the respective two-dimensional detection data are compared with one another, and the two-dimensional detection data having the maximum total X-ray intensity is extracted as the peak two-dimensional detection data (step S2).

In the example shown in FIG. 4, the two-dimensional detection data of data No. 320 has the maximum total X-ray intensity recorded i in the entire region of the two-dimensional image, so that the two-dimensional detection data of this data No. 320 is extracted as the peak two-dimensional detection data.

Next, the peak position identifying unit 212 identifies, from the peak two-dimensional detection data, the position (peak position) where the X-ray intensity is maximum (step S3). As described above, in the present embodiment, the peak position recorded in the two-dimensional image of the peak two-dimensional detection data (the position where the diffraction peak 10 is stored) is identified by the offset amounts Δω and Δχ from the reference detection point P0 (see FIG. 8).

Next, the target region setting unit 221 sets a target region 20 having an arbitrary size so as to surround the peak position based on instruction information from an operator which is inputted via an input device such as a keyboard (see FIG. 5B, step S4).

The profile creating unit 222 integrates the X-ray intensities in the region corresponding to the target region 20 for each two-dimensional detection data of the diffracted X-rays Xb obtained at a plurality of scan angles 2θ/θ, and creates a rocking curve profile based on the integrated X-ray intensity for each two-dimensional detection data (see FIG. 9, step S5). The specific processing at this time has been described above, and (2θ/θ)±Δω is set as the scan angle of the two-dimensional detection data by considering the offset amount Δω for the scan angle 2θ/θ under the measurement.

### [Data Processing Unit for Evaluating Sample Warpage]

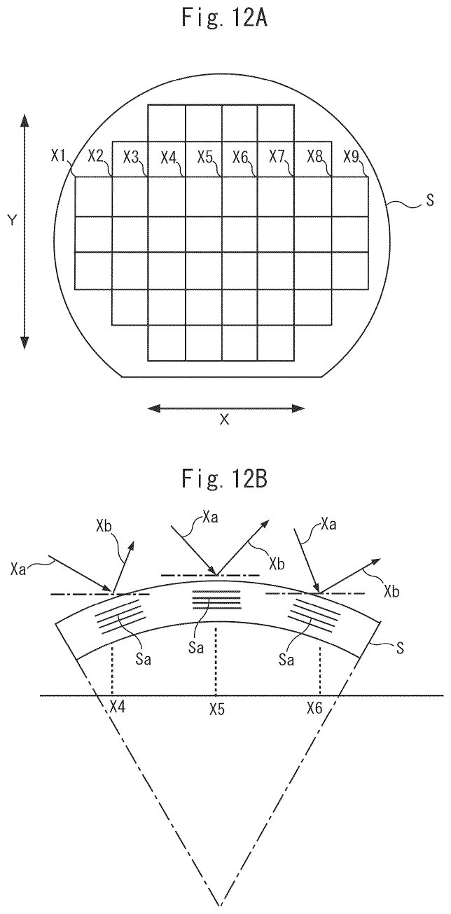

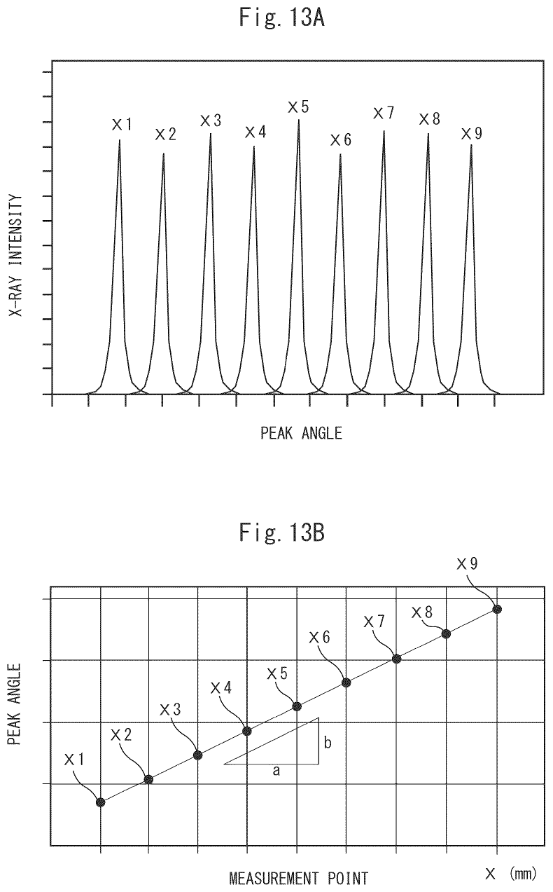

Next, the data processing unit for evaluating sample warpage 230 shown in FIG. 3 will be described with reference to FIG. 12A to FIG. 13B.

The data processing unit for evaluating sample warpage 230 includes the functional units of a peak shift amount calculating unit 231 and a radius-of-curvature calculating unit 232 (see FIG. 3).

As shown in FIG. 12A, the operator sets a plurality of measurement points X1 to X9 linearly on the surface of the thin-film substrate sample S, and performs rocking curve measurement for the plurality of measurement points.

Two-dimensional detection data at each scan angle 2θ/θ acquired by the rocking curve measurement at each measurement point is stored in the storage unit 202. Furthermore, the peak two-dimensional detection data extracting unit 211 extracts, from these two-dimensional detection data, two-dimensional detection data (peak two-dimensional detection data) of the diffracted X-rays Xb in which the X-ray intensity is maximum.

The peak shift amount calculating unit 231 compares the scan angles 2θ/θ of the peak two-dimensional detection data acquired for the respective measurement points X1 to X9 with one another to determine the shift amounts of the scan angle 2θ/θ.

In other words, if the thin-film substrate sample S is warped, for example, as shown in FIG. 12B, the crystal lattice planes Sa would be tilted, so that the angular direction in which the diffracted X-rays Xb appear would change.

Therefore, the scan angle 2θ/θ of the peak two-dimensional detection data is shifting according to the tilt of the crystal lattice plane Sa (that is, the angle of warpage).

The peak shift amount calculating unit 231 compares the scan angles 2θ/θ of the peak two-dimensional detection data at each of the measurement points X1 to X9 (hereinafter sometimes abbreviated to peak angle) to calculate the shift amount.

FIG. 13A is an example of a graph showing the peak values of the diffracted X-rays Xb intensities for respective measurement points arranged along the peak angle, and FIG. 13B is an example of a graph showing the relations between the peak angle and the position of each measurement point.

When the thin-film substrate sample S is warped, for example, as shown in FIG. 13A, the peak angle indicating the peak value of the diffracted X-rays Xb intensity for each measurement point shifts horizontally. Furthermore, for example, as shown in FIG. 13B, the peak angle shifts linearly for each measurement point.

The radius-of-curvature calculating unit 232 calculates the radius of curvature of the crystal lattice planes of the thin-film substrate sample S based on the shift amount of the peak angle calculated by the peak shift amount calculating unit 231. Specifically, it is possible to determine the radius of curvature of the crystal lattice planes of the thin-film substrate sample S from the gradient (b/a) of a straight line displayed in the graph of FIG. 13B.

### [Data Processing Unit for Adjusting Sample Height and Sample Stage Controller]

Next, the data processing unit for adjusting the sample height 240 shown in FIG. 3 and the function of the controller 101 shown in FIG. 2 as a sample stage controller will be described.

Returning to FIG. 3, a reference height position at which the surface of sample S should be placed in the X-ray diffraction device 100 is stored in advance in the storage unit 202. Usually, this reference height position is set to the height of the rotation center of the goniometer 140. Furthermore, the peak position of the peak two-dimensional detection data when the surface of sample S is located at the reference height position is stored in advance in the storage unit 202.

The operator performs rocking curve measurement.

The two-dimensional detection data for each scan angle 2θ/θ which is acquired by the rocking curve measurement is stored in the storage unit 202. Furthermore, the peak two-dimensional detection data extracting unit 211 extracts two-dimensional detection data (peak two-dimensional detection data) of the diffracted X-rays Xb presenting the maximum X-ray intensity from the two-dimensional detection data. Next, the peak position identifying unit 212 identifies the position (peak position) at which the X-ray intensity is maximum in the peak two-dimensional detection data.

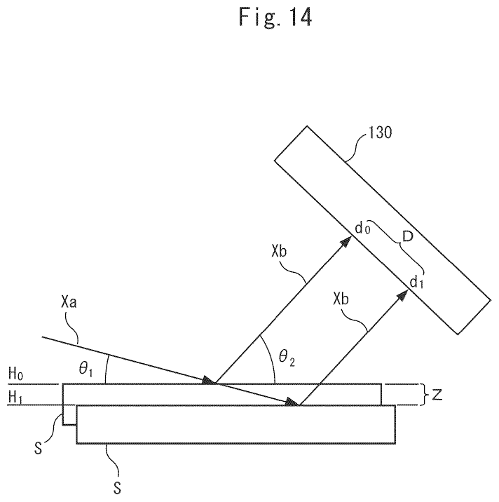

FIG. 14 is a schematic diagram showing the relation between the change in height of the sample S and the shift amount of the peak position in the peak two-dimensional detection data.

The surface height of the sample S under the rocking curve measurement is represented by, for example, H₁ in FIG. 14, and the peak position of the peak two-dimensional detection data acquired by the rocking curve measurement is assumed to be located at position P₁ on the detection surface of the two-dimensional X-ray detector 130.

Furthermore, the reference height position is represented by, for example, H₀ in FIG. 14, and the peak position of the peak two-dimensional detection data when the surface of the sample S is located at this reference height position H₀ is assumed to be located at position P₀ on the detection surface of the two-dimensional X-ray detector 130.

As shown in FIG. 3, the data processing unit for adjusting the sample height 240 of the X-ray diffraction data processing device 200 includes respective functional units of a peak position offset amount calculating unit 241 and a height deviation amount calculating unit 242.

The peak position offset amount calculating unit 241 determines an offset amount D of a peak position di of peak two-dimensional detection data acquired by the rocking curve measurement from a peak position do of peak two-dimensional detection data acquired when the surface of the sample S is located at the reference height position H₀.

In FIG. 14, if the incident angle θ₁ of the incident X-rays Xa with respect to the surface of the sample S, the diffraction angle θ₂ of the diffracted X-rays Xb with respect to the surface of the sample S, and the offset amount D are known, how much the height H₁ of the surface of the sample S under the rocking curve measurement deviates from the reference height position H₀, that is, the deviation amount (height deviation amount) Z can be calculated by the following formula (1). This calculation processing is executed by the height deviation amount calculating unit 242.

$$\begin{matrix}[ Formula 1 ] & \\ Z = \frac{D}{sin {θ}_{2} ( \frac{1}{tan {θ}_{1}} + \frac{1}{tan {θ}_{2}} )} & ( 1 )\end{matrix}$$

The controller 101 shown in FIG. 2 also functions as a sample stage controller for controlling the height of the sample stage 110.

In other words, the controller 101 adjusts the movement based on the height deviation amount Z calculated by the height deviation amount calculating unit 242 such that the height of the surface of the sample S is equal to the reference height.

Since the height deviation amount Z could be calculated from the offset amount D of the peak position, the controller 101 adjusts the height of the sample stage 110 based on the peak position in the peak two-dimensional detection data.

The present invention is not limited to the above-described embodiment.

In the above-described embodiment, there has been described a configuration example in which the present invention is applied to an X-ray analysis device for analyzing the composition, film thickness, etc. of a thin film by rocking curve measurement using a thin-film substrate as a sample S, but it is needless to say that the use of the present invention is not limited to this configuration example.

For example, the present invention can also be applied to X-ray analysis of samples other than thin-film substrate samples S. Furthermore, the invention of claim 1 which performs data processing using position information of a peak position identified for peak two-dimensional detection data, the invention of claim 6 relating to evaluation of warpage of the sample S, and the invention of claim 8 relating to height adjustment of the sample S can all be applied to an X-ray analysis device that performs measurements other than a rocking curve measurement.

1. An X-ray diffraction data processing device for scanning an incident angle θ of incident X-rays and an angular direction of 2θ in which a two-dimensional X-ray detector is arranged, and processing two-dimensional detection data of diffracted X-rays obtained at a plurality of scan angles 2θ/θ by using an X-ray analysis device in which a measurement point set on a surface of a sample is irradiated with the incident X-rays in a direction of the incident angle θ, the two-dimensional X-ray detector is arranged in the angular direction of 2θ with respect to the direction of the incident angle θ, and diffracted X-rays diffracted by the sample are detected by the two-dimensional X-ray detector, comprising:
a peak two-dimensional detection data extracting unit for extracting two-dimensional detection data of diffracted X-rays presenting maximum X-ray intensity (peak two-dimensional detection data) from the two-dimensional detection data of the diffracted X-rays obtained at the plurality of scan angles 2θ/θ;
a peak position identifying unit for identifying, from the peak two-dimensional detection data, a position at which X-ray intensity is maximum (peak position); and
a data processing unit for executing data processing using position information of the peak position identified for the peak two-dimensional detection data.

2. The X-ray diffraction data processing device according to claim 1, wherein the data processing unit comprises:
a target region setting unit for setting a target region surrounding the peak position; and
a profile creating unit for integrating X-ray intensities within a region corresponding to the target region for each of the two-dimensional detection data of the diffracted X-rays obtained at the plurality of scan angles 2θ/θ, and creating a rocking curve profile based on X-ray intensity integrated for each of the two-dimensional detection data.

3. The X-ray diffraction data processing device according to claim 1, wherein:
the two-dimensional X-ray detector has a detection surface for detecting diffracted X-rays, and a reference detection point is set in advance on the detection surface;
Application No.: Not Yet Assigned Docket No.: P240851US00 the two-dimensional X-ray detector is arranged such that when a surface of a symmetrically reflective sample is irradiated with incident X-rays in a direction of an incident angle θ, an optical axis of diffracted X-rays appearing from the surface of the sample in a direction of a diffraction angle 2θ is incident onto the reference detection point; and
the peak position identifying unit is configured to determine an offset amount between the peak position recorded in the peak two-dimensional detection data and the reference detection point.

4. The X-ray diffraction data processing device according to claim 3, wherein the peak position identifying unit is configured to determine Δω and Δχ as offset amounts between the peak position and the reference detection point, where Δω represents an offset amount along a locus ω of the reference detection point caused by 2θ/θ scan, and Δχ represents an offset amount along a circular locus χ centered on the reference detection point at a scan angle 2θ/θ=0°.

5. The X-ray diffraction data processing device according to claim 2, wherein the target region setting unit has a function of arbitrarily adjusting a width of the target region surrounding the peak position, the width corresponding to the angular direction of 2θ.

6. The X-ray diffraction data processing device according to claim 1, wherein the data processing unit comprises:
a peak shift amount calculating unit for calculating a shift amount of the scan angle 2θ/θ by comparing the scan angled 2θ/θ of the peak two-dimensional detection data acquired for a plurality of measurement points on a straight line set on the surface of the sample that is a flat sample; and
a radius-of-curvature calculating unit for calculating a radius of curvature of crystal lattice planes of the sample based on the shift amount of the scan angle 2θ/θ calculated by the peak shift amount calculating unit.

7. An X-ray analysis device in which a measurement point set on a surface of a sample is irradiated with incident X-rays in a direction of an incident angle θ, a two-dimensional X-ray detector is arranged in an angular direction of 2θ with respect to the direction of the incident angle θ, and diffracted X-rays diffracted by the sample are detected by the two-dimensional X-ray detector, comprising the X-ray diffraction data processing device according to any one of claim 1.

8. The X-ray analysis device according to claim 7, further comprising:
a sample stage for placing the sample thereon, the sample stage being freely movable up and down; and
a sample stage controller having a function of controlling at least a height of the sample stage, wherein the sample stage controller is configured to adjust the height of the sample stage based on the peak position related to the peak two-dimensional detection data.

9. An X-ray diffraction data processing method to be performed by an X-ray diffraction data processing device for scanning an incident angle θ of incident X-rays and an angular direction of 2θ in which a two-dimensional X-ray detector is arranged, and processing two-dimensional detection data of diffracted X-rays obtained at a plurality of scan angles 2θ/θ in an X-ray analysis device in which a measurement point set on a surface of a sample is irradiated with the incident X-rays in a direction of the incident angle θ, the two-dimensional X-ray detector is arranged in the angular direction of 2θ with respect to the direction of the incident angle θ, and diffracted X-rays diffracted by the sample are detected by the two-dimensional X-ray detector, the X-ray diffraction data processing method comprising:
a peak two-dimensional detection data extracting step of extracting two-dimensional detection data of diffracted X-rays presenting maximum X-ray intensity (peak two-dimensional detection data) from the two-dimensional detection data of the diffracted X-rays obtained at the plurality of scan angles 2θ/θ;
a peak position identifying step of identifying, from the peak two-dimensional detection data, a position at which X-ray intensity is maximum (peak position); and
a data processing step of executing data processing using position information of the peak position identified for the peak two-dimensional detection data.

10. An X-ray diffraction data processing program to be executed by an X-ray diffraction data processing device for scanning an incident angle θ of incident X-rays and an angular direction of 2θ in which a two-dimensional X-ray detector is arranged, and processing two-dimensional detection data of diffracted X-rays obtained at a plurality of scan angles 2θ/θ in an X-ray analysis device in which a measurement point set on a surface of a sample is irradiated with the incident X-rays in a direction of the incident angle θ, the two-dimensional X-ray detector is arranged in the angular direction of 2θ with respect to the direction of the incident angle θ, and diffracted X-rays diffracted by the sample are detected by the two-dimensional X-ray detector, the X-ray diffraction data processing program comprising:
a peak two-dimensional detection data extracting step of extracting two-dimensional detection data of diffracted X-rays presenting maximum X-ray intensity (peak two-dimensional detection data) from the two-dimensional detection data of the diffracted X-rays obtained at the plurality of scan angles 2θ/θ;
a peak position identifying step of identifying, from the peak two-dimensional detection data, a position at which X-ray intensity is maximum (peak position); and
a data processing step of executing data processing using position information of the peak position identified for the peak two-dimensional detection data.
